(19) United States
(12) Patent Application Publication
(10) Pub. No.: US 2014/0056125 A1
(43) Pub. Date: Feb. 27, 2014

(54) Stability Site for VPLS Multi-Homing

(71) Applicant: CenturyLink Intellectual Property LLC, Denver, CO (US)

(72) Inventors: Ahmed Guellal, Arlington, VA (US); Shaohong Li, Fairfax, VA (US)

(73) Assignee: CenturyLink Intellectual Property LLC, Denver, CO (US)

(21) Appl. No.: 13/974,132

(22) Filed: Aug. 23, 2013

Related U.S. Application Data
(60) Provisional application No. 61/693,007, filed on Aug. 24, 2012.

(51) Int. Cl. H04L 12/703

(52) U.S. Cl. CPC H04L 45/28
USPC 370/225

(57) ABSTRACT

Novel tools and techniques are described for mitigating data loss during failover in a VPLS multi-homed network. In one aspect, a primary link might be established between a lowest numbered provider edge (“PE”) router in the service provider network and a lowest numbered physical site at customer premises outside the service provider network. A stability site might be established within the service provider network, communicatively coupled to at least the lowest numbered PE router via a primary virtual circuit. The stability site might be designated as the lowest numbered virtual site, which might have a site ID number lower than the lowest numbered physical site. In response to the primary link failing or becoming broken, one or more backup virtual circuits might be established between a plurality of ingress PE routers and a plurality of egress PE routers in the service provider network, without destroying the primary virtual circuit.

### CROSS REFERENCE TO RELATED APPLICATIONS

This application claims the benefit, under 35 U.S.C. §119, of provisional U.S. Application No. 61/693,007, filed Aug. 24, 2012 by Gulleal et al. and titled, “Stability Site for VPLS Multi-homing” (attorney docket no. 020370-007301US), the entire disclosure of which is incorporated herein by reference.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to a method, system, and apparatus associated with VPLS Multi-homing, and, more particularly, to a method, system, and apparatus associated with stability sites for VPLS Multi-homing.

### BACKGROUND

In a virtual private local area network (“LAN) service (“VPLS”) multihoming network where many POPs are connected though VC (Virtual circuits) and many virtual LANs (“VLANs”) are present, there is a flaw in RFC 4761, which does not account for network outages on both failure and restoration stages. VPLS Multihoming is typically used for redundancy. The switches which provide access to the many VLANS are connected to two provider edge (“PE”) routers. In the same point of presence (“POP”), one of the PE routers will act as a primary whereas the other will be backup. Virtual Circuits (“VC”) interconnect POPS at a layer 2 level using VPLS. The VC is setup between primary PEs only. Note that by default, the VC will identify the Primary as PE associated with the lowest site ID within the same POP.

If a primary link breaks between one of the lowest numbered site pair connecting two POPS within the service provider VPLS network, a new VC must be established based on the next lowest numbered site pair until the broken primary link has been repaired. This results in a substantial loss of traffic. When the link is repaired, the VC will automatically switch back the initial lowest numbered sire pair, and that will result in another loss of traffic. Note that restoration of a service is expected not to result in loss of service especially to the “non-affected” site IDs, which is not the case here.

Because of the need to establish the new LSI interface due to outage or restoration of the same outage, data loss may occur due to one or both of “convergence time data loss” and/or “back door MAC learning data loss.”

### BRIEF SUMMARY

Various embodiments provide techniques to enable mitigating data loss during failover in a VPLS multi-homed network. In one aspect, a first primary link might be established between a first lowest numbered provider edge (“PE”) router in the service provider network and a first lowest numbered physical site at customer premises outside the service provider network. A first stability site might be established within the service provider network, communicatively coupled to at least the first lowest numbered PE router via a first primary virtual circuit. The first stability site might be designated as the first lowest numbered virtual site. A second primary link might be established between a second lowest numbered PE router in the service provider network and a second lowest numbered physical site at customer premises outside the service provider network. A second stability site might be established within the service provider network, communicatively coupled to at least the second lowest numbered PE router via a second primary virtual circuit. The second stability site might be designated as the second lowest numbered virtual site. The first lowest numbered virtual site and the second lowest numbered virtual site might each have a site ID number lower than either the first lowest numbered physical site or the second lowest numbered physical site.

In response to at least one of the first primary link or the second primary link failing or becoming broken, one or more backup virtual circuits might be established between a plurality of ingress PE routers and a plurality of egress PE routers in the service provider network, without destroying the first or second primary virtual circuit.

Because the first and second primary virtual circuits are not destroyed, a new LSI interface is not necessary. As a result, data loss due to one or both of “convergence time data loss” or “back door MAC learning data loss” may be mitigated or eliminated.

In one aspect, a method might be provided for mitigating data loss during failover in a VPLS multi-homed network. Data loss might occur due to one or both of “convergence time data loss” and “back door MAC learning data loss.” The method might comprise providing a VPLS multi-homed network comprising a plurality of first provider edge (“PE”) routers and a plurality of second PE routers. The plurality of first and second PE routers might be located within a service provider network. The plurality of first PE routers might include a first lowest numbered PE router, while the plurality of second PE routers might include a second lowest numbered PE router. Each of the plurality of first PE routers might be in network communication with one or more first customer edge (“CE”) devices located within one or more first customer sites outside of the service provider network. The one or more first CE devices might be connected to a plurality of first virtual local area networks (“VLANs”) at the one or more first customer sites. The one or more first customer sites might include a first lowest numbered physical site.

Each of the plurality of second PE routers might be in network communication with one or more second CE devices located within one or more second customer sites outside of the service provider network. The one or more second customer sites might be separate from the one or more first customer sites. The one or more second CE devices might be connected to the plurality of second VLANs at the one or more second customer sites. The one or more second customer sites might include a second lowest numbered physical site.

The method might further comprise establishing a first primary link between the first lowest numbered PE router and the first lowest numbered physical site, and establishing a second primary link between the second lowest numbered PE router and the second lowest numbered physical site.

The method might comprise establishing a first stability site within the service provider network, communicatively coupling the first stability site to at least the first lowest numbered PE router via a first virtual circuit, and designating the first stability site as a first lowest numbered virtual site. The first lowest numbered virtual site might have a site ID number lower than either the first lowest numbered physical site or the second lowest numbered physical site.

The method might further comprise establishing a second stability site within the service provider network, communicatively coupling the second stability site to at least the second lowest numbered PE router via a second virtual circuit, and designating the second stability site as a second lowest numbered virtual site. The second lowest numbered virtual site might have a site ID number lower than either the first lowest numbered physical site or the second lowest numbered physical site.

In some embodiments, the method might comprise, in response to at least one of the first primary link or the second primary link failing (or becoming broken), establishing one or more backup virtual circuits between the plurality of first PE routers and the plurality of second PE routers, without destroying any of the first or second virtual circuits.

In another aspect, a VPLS multi-homed network system might be provided. The system might comprise a plurality of first provider edge (“PE”) routers located within a service provider network. The plurality of first PE routers might include a first lowest numbered PE router. Each of the plurality of first PE routers might be in network communication with one or more first customer edge (“CE”) devices located within one or more first customer sites outside of the service provider network. The one or more first CE devices might be connected to a plurality of first virtual local area networks (“VLANs”) at the one or more first customer sites. The one or more first customer sites might include a first lowest numbered physical site.

The system might further comprise a plurality of second PE routers located within the service provider network. The plurality of second PE routers might include a second lowest numbered PE router. Each of the plurality of second PE routers might be in network communication with one or more second CE devices located within one or more second customer sites outside of the service provider network. The one or more second customer sites might be separate from the one or more first customer sites. The one or more second CE devices might be connected to the plurality of second VLANs at the one or more second customer sites. The one or more second customer sites might include a second lowest numbered physical site.

The system might comprise a first primary link established between the first lowest numbered PE router and the first lowest numbered physical site, and a second primary link established between the second lowest numbered PE router and the second lowest numbered physical site.

The system might further comprise a first stability site communicatively coupled to at least the first lowest numbered PE router via a first virtual circuit. The first stability site might be located within the service provider network. The first stability site might be designated as a first lowest numbered virtual site, and the first lowest numbered virtual site might have a site ID number lower than either the first lowest numbered physical site or the second lowest numbered physical site.

The system might comprise a second stability site communicatively coupled to at least the second lowest numbered PE router via a second virtual circuit. The second stability site might be located within the service provider network. The second stability site might be designated as a second lowest numbered virtual site, and the second lowest numbered virtual site might have a site ID number lower than either the first lowest numbered physical site or the second lowest numbered physical site.

The system might further comprise one or more backup virtual circuits established between the plurality of first PE routers and the plurality of second PE routers, the one or more backup virtual circuits being established in response to at least one of the first primary link or the second primary link failing (or becoming broken). The one or more backup virtual circuits might be established without destroying any of the first or second virtual circuits.

In yet another aspect, a provider edge (“PE”) router apparatus might be provided. The PE router might be the lowest numbered PE router amongst a plurality of PE routers in a VPLS multi-homed network. The PE router might comprise a first port, a second port, and a third port.

The first port might be communicatively coupled to one of a second PE router within the service provider network via a first primary virtual circuit or a first lowest numbered customer edge (“CE”) device located within a first customer site outside of the service provider network via a first primary link. The first lowest numbered CE device might be connected to a plurality of first virtual local area networks (“VLANs”) at the first customer site, the first customer site being a first lowest numbered physical site.

The second port might be communicatively coupled to one of a third PE router within the service provider network via a second primary virtual circuit or a second lowest numbered CE device located within a second customer site outside of the service provider network via a second primary link. The second customer site might be separate, or geographically distant, from the first customer site. The second lowest numbered CE device might be connected to a plurality of second VLANs at the second customer site, the second customer site being the second lowest numbered physical site.

The third port might be communicatively coupled to a stability site via a first virtual circuit, wherein the stability site might be located within the service provider network and might be designated as a first lowest numbered virtual site. The first lowest numbered virtual site might have a site ID number lower than either the first lowest numbered physical site or the second lowest numbered physical site.

In response to at least one of the first primary link or the second primary link failing (or becoming broken), one or more backup virtual circuits might be established between the second PE router and the third PE router, without destroying the first virtual circuit.

In some embodiments, the third port might be communicatively coupled to the stability site via a first switch. In other embodiments, the PE router might comprise a fourth port, and the stability site might comprise a physical loopback communicatively coupled to the third port at one end and communicatively coupled to the fourth port at the other end. The third port, according to some embodiments, might include a logical port, and the stability site might comprise a logical loopback at the third port.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a general schematic diagram of a VPLS Multi-homing Network, in accordance with various embodiments.

FIG. 2A is a general schematic diagram of a VPLS Multi-homing Network in operation, in accordance with various embodiments.

FIGS. 2B-2D are general schematic diagrams of a VPLS Multi-homing Network in operation in response to a broken primary link, in accordance with various embodiments.

FIG. 3 is a general schematic diagram of a VPLS Multi-homing Network with Stability Sites, in accordance with various embodiments.

FIG. 4A is a general schematic diagram of a VPLS Multi-homing Network with Stability Sites in operation, in accordance with various embodiments.

FIG. 4B is a general schematic diagram of a VPLS Multi-homing Network with Stability Sites in operation with a broken primary link, in accordance with various embodiments.

FIG. 5 is a flow chart of a method of implementing Stability Sites in a VPLS Multi-homing Network, in accordance with various embodiments.

FIG. 6 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Herein, the term “Multi-protocol Label Switching” (“MPLS”) refers to a technique for high performance telecommunications networks to direct and carry data from one network node to the next, by creating label switched paths between distant nodes, assigning or allocating labels to data packets, and making packet-forwarding decisions based solely on the contents of the labels without examining the packet itself. The terms “Border Gateway Protocol” (“BGP”) and “Multi-Protocol Border Gateway Protocol” (“MP-BGP”) are, for the purposes of this disclosure, interchangeable, and refer to a gateway protocol that routers and similar devices employ in order to exchange appropriate levels of routing information. In some cases, MPBGP is used as a layer 2 signaling protocol, which will be used to allocate labels to all possible combinations of VC pairs that connect multiple site IDs associated to the respective POPS for every VLAN. The other function for MPBGP is for a router in a POP to dynamically identify which of the remote POP router PE is the primary PE and which is backup. Note that this can apply to all VLANs. The tracking of primary versus secondary uses the BGP attribute of local preference. Merely by way of example, a primary PE might be associated with a local preference of 1 whereas a secondary PE could be assigned a local preference of 65535.

The terms “Multi-homing,” “Multihoming,” “Multi-homed,” “Multihomed,” and the like are interchangeable, and refer to components including, but not limited to, customer edge (“CE”) devices, and/or the like being connected to multiple PEs simultaneously. CE devices refer to devices (including, without limitation as layer 2 devices, routers configured to bridge, switches, and the like) that are part of a customer network and that interface with PE devices (including, but not limited to, routers, switches, and the like). The term “Virtual Private LAN Services” (“VPLS”) refers to a class of virtual private network (“VPN”) that allows the connection of multiple sites in a single bridged domain over a service provider-managed MPLS network.

As understood in the art, a Media Access Control (“MAC”) address is the hardware address of a computer or communicating device intended to be linked to a wireless or wired shared network, including but not limited to a local area network (“LAN”), a virtual LAN (“VLAN”), a VPN, the Internet, or the like. The MAC address is typically hard-coded into the device, and thus cannot change; no two devices have the same MAC address. A MAC table refers to a table that might be used for establishing or selecting virtual circuits (“VCs”) between PE devices, for establishing or selecting attachment circuits (“ACs”) between CE devices and PE devices, and/or for establishing paths between devices within the VPLS network. “MAC Flushing” or a “MAC Flush” refers to a flushing of the listing of MAC addresses in a MAC table, so that correct MAC address learning can be performed, as described in detail below. “Junos code” refers to the operating system created by Juniper Networks for its routers; herein “Junos code” might refer specifically to RFC 4761, which is the preferred solution for CE Multi-homed implementation. The term “POP” refers to point of presence—or more specifically, in this disclosure, to Internet point of presence, which is an access point to the Internet. A POP is a physical location in which servers, routers, and the like are housed, and may be part of, or separate from, the facilities of a service provider (such as an Internet service provider (“ISP”)). An “SLA” refers to a service level agreement, which is an agreement between a user and a service provider that defines the nature of the service provided and establishes a set of metrics for use in measuring the measured level of service provided compared with the agreed level of service.

Herein also, “links,” “virtual links,” “LSPs” and “paths” are, for purposes of this disclosure, synonymous terms that refer to a label switched path between nodes in the network (i.e., between PE devices).

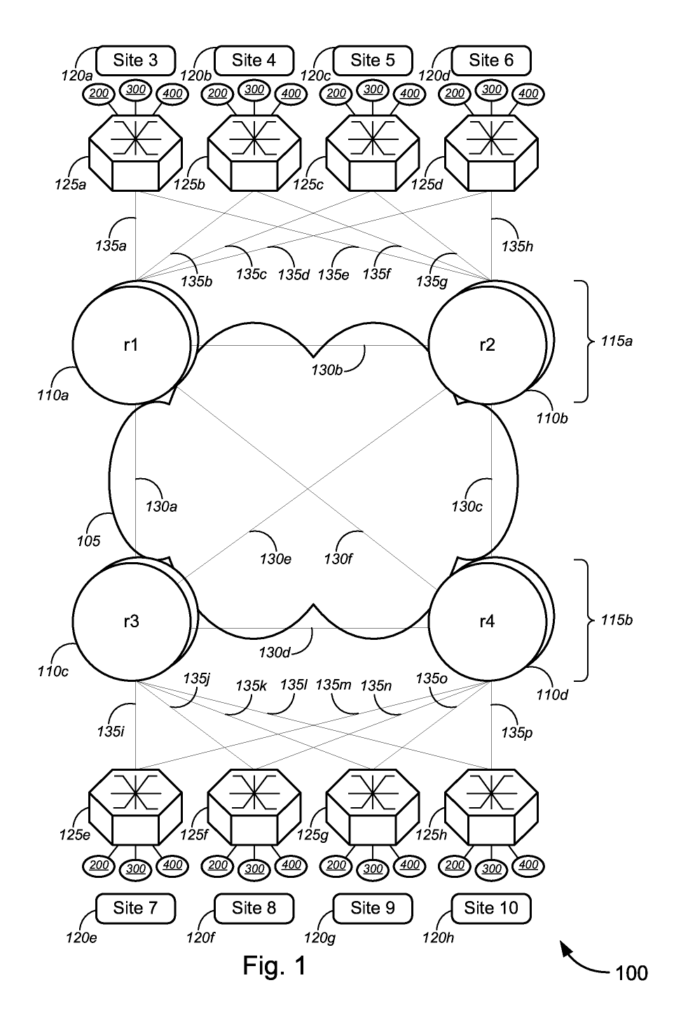

FIGS. 1-6 illustrate some of the features of the method and system for implementing a VPLS Multi-homing Network as referred to above. The methods and systems illustrated by FIGS. 1-6 refer to examples of different embodiments that include various components and steps, which can be considered alternatives or which can be used in conjunction with one another in the various embodiments. The description of the illustrated methods and systems shown in FIGS. 1-6 is provided for purposes of illustration and should not be considered to limit the scope of the different embodiments.

FIG. 1 illustrates a general schematic diagram of a VPLS Multi-homing Network 100, in accordance with various embodiments. In FIG. 1, the VPLS Multi-homing Network 100 comprises network 105, a plurality of PE devices 110, one or more POPs 115, a plurality of physical sites 120, a plurality of CE devices 125, a plurality of virtual circuit (“VC”) links 130, a plurality of attachment circuit (“AC”) links 135, and one or more virtual local area networks (“VLANs”) 200, 300, and 400.

Network 105 may be implemented as an MPLS-based network using either label distribution protocol (“LDP”) or reservation protocol (“RSVP”) as signaling protocols. It typically runs either open shortest path first (OSPF) or intermediate system-to-intermediate system (“IS-IS”) as interior gateway protocols (“IGP”). The plurality of PE devices 110 can be any type of telecommunications device that might be found at a service provider facility, including, but not limited to, routers, switches, and the like. For example, the plurality of PE devices 110 in network 105 of the VPLS Multi-homing Network 100 might comprise PE routers 110a-110d (also designated r1-r4). In some embodiments, the one or more POPs 115 might comprise POP 115a and POP 115b. In other embodiments, the one or more POPs 115 might comprise hundreds or thousands of POPs. In the example of FIG. 1, PE routers r1 and r2 (i.e., routers 110a and 110b) might comprise POP 115a (otherwise referred to in the embodiments of FIGS. 1-4 as “North POP”), while PE routers r3 and r4 (i.e., routers 110c and 110d) might comprise POP 115b (otherwise referred to in the embodiments of FIGS. 1-4 as “South POP”). In some embodiments, the PE routers r1-r4 (i.e., PE devices 110a-110d) might maintain and exchange VPLS related information with other PE routers in a signaling operation, and might use MPLS label switched paths (“LSPs”) to carry the VPN traffic and to perform MAC learning functions.

The plurality of sites 120 might each comprise one or more customer premises, and might represent physical locations at which user computers, servers, databases, and the like might be physically located. Each site 120 is logically associated with a corresponding device 125. For instance, site 120e is associated with CE device 125e. In some embodiments, the VPLS Multi-homing Network 100 might comprise physical sites 120a-120h (otherwise referred to as “Sites 3-10”). The plurality of CE devices 125 can be any type of telecommunications device that might be found at a customer facility or at customer premises, including, but not limited to, routers, switches, and the like. For example, the plurality of CE devices 125 in the VPLS Multi-homing Network 100 might comprise CE switches 125a-125h. Customers typically connect their devices and associate them to different VLANs, e.g., VLAN 200. The plurality of VC links 130 might include links 130a-130f, which might represent a link between each and every PE router 110a-110d. The plurality of AC links 135 might include links 135a-135p. Links 135a-135d might represent connections between PE router r1 (i.e., PE router 110a) and each of CE switches 125a-125d, and links 135e-135h might represent connections between PE router r2 (i.e., PE router 110b) and each of CE switches 125a-125d. Likewise, links 135i-1351 might represent connections between PE router r3 (i.e., PE router 110c) and each of CE switches 125e-125h, while links 135m-135p might represent connections between PE router r4 (i.e., PE router 110d) and each of CE switches 125e-125h. The CE devices 125 might utilize Ethernet connections, and might be connected by a VPLS service to the PE devices 110. Although each CE switch 125 is shown in FIG. 1 as connected to only two PE routers 110, the various embodiments are not so limited, and each CE switch 125 may be linked to any suitable number of PE routers 110.

The network 100 might operate as a single LAN segment running three different VLANs 200, 300, and 400, which might be established amongst some or all of the physical sites 120 (i.e., Sites 3 through 10) within the VPLS Multi-homing Network 100, via one or more of the plurality of PE devices 110. In some embodiments, VLANs 200, 300, and 400 might comprise the same user computers and the like at each physical site 120a-120h, while in other embodiments, each of VLANs 200, 300, and 400 might comprise at least some user computers and the like at each physical site 120a-120h that are different from those for the other ones of VLANs 200, 300, and 400.

The connection of the CE devices 125 and PE devices 110 to VLANs 200, 300, and 400 simultaneously represents the Multi-homing nature of VPLS network 100, which might be a service provider-managed MPLS network. A VPLS Multi-homing architecture, such as network 100, might be employed to fulfill one or more of the following requirements: (1) a need for redundancy to meet aggressive SLAs; (2) a need for loop avoidance without running a signal transfer point (“STP”) by design or running STP to address a limitation, such as a lack of support for Per-VLAN Spanning Tree (“PVST”), which allows traffic from different VLANs within a multiple VLAN network to use different links by the creation of multiple spanning trees; and/or (3) a need for fast convergence.

In an MPLS network, such as in an MPLS component of the VPLS Multi-homing network 100, the PE routers 110 might comprise a first set of PE routers 110 that might serve as label edge routers (“LERs”). LERs might create an MPLS header containing one or more labels (hereinafter referred to as a “label stack”) prefixed to a data packet, if one is not already present. The created label stack might indicate which path or paths to route the data packet. If an MPLS header has already been created in the data packet, the PE router or LER might “push” or “impose” an MPLS label onto the label stack, “pop” or “dispose of” an MPLS label from the label stack, or “swap” an old MPLS label in the label stack with a new MPLS label. The “push,” “pop,” or “swap” operations might depend on determinations of any changes in route or path. The LERs are typically at the edge of the MPLS VPN and serve as either an ingress router (which receives data packets from CE devices 125) or an egress router (which sends data packets to CE devices 125), hence the “edge” in label edge router. An ingress router might “push” or “swap” labels in the label stack as the data packet enters the MPLS VPN (such as network 105), while an egress router might “pop” labels off the label stack as the data packet leaves the MPLS VPN (such as network 105).

The PE routers 110 might further comprise a second set of PE routers 110 that might serve as label switch routers (“LSRs”). LSRs are routers that perform routing of the data packets based only on the label in the label stack of the data packets. The contents of the data packets do not matter for routing purposes, and thus are not examined by the LSRs. Generally, only the top-most label in the label stack is important for routing the data packet to the next node in the network. As such, LSRs only need to examine the top-most label to perform routing of the data packet. In operation, when a data packet is transferred to one of the second set of PE routers (i.e., one of the LSRs), the PE router or LSR might route the data packet based only on the top-most label in the label stack of the data packet, thus allowing for quick and efficient routing of data packets within the network. The second set of PE routers or LSRs might regularly exchange label and reachability information with each other using standardized procedures (which are known to those skilled in the art) in order to build a complete picture of the network 105.

According to some embodiments, the first and second sets of PE routers might be embodied as one type of router; in other words, the PE routers (such as PE routers 110) might serve as both LERs and LSRs. In some embodiments, the PE routers 110 might further include routers that merely function as transit routers without either modifying the labels in the label stack of the data packets (i.e., without serving as an LER) or routing the data packets based on the labels (i.e., without serving as an LSR). Such transit routers are commonly referred to as provider routers or “P routers,” and might typically be located between LERs in any given path with the VPLS network 105.

VPLS is a layer 2 VPN that allows for geographically distant or dispersed sites to share an Ethernet network via, for example, Ethernet over MPLS, which might connect the distant sites via virtual circuits (“VC”). In a VPLS network, such as VPLS network 100 shown in FIG. 1, VLANs 200, 300, and 400 at each site (Sites 3-10) might be extended to an edge of the provider network 105, which might function as a switch or bridge to connect all of the LANs 200, 300, and 400 at all of the sites (Sites 3-10) thus creating a single-bridged LAN for each of VLANs 200, 300, and 400.

Because VPLS effectively emulates a LAN, full mesh connectivity is required. Methods for establishing full mesh connectivity in the VPLS include, but are not limited to, label distribution protocol (“LDP”) and border gateway protocol (“BGP”), or the like. The VPLS MPLS network 105 comprises two planes: a “control plane” and a “data plane.” The control plane allows the PE routers 110 to communicate with each other for auto-discovery and for signaling. Auto-discovery is the process of finding other PE routers 110 within the same VPN or VPLS network, while signaling is the process of establishing VCs or links between PE routers 110 in the layer 2 VPN or VPLS network. The data plane is defined by the VCs, through which data packets in the VPN or VPLS traffic might be sent from one PE router 110 to another PE router 110 within the network 105.

The use of MPLS with Fast Reroute or Facility Bypass as the underlying technology for the data plane allows traffic to be automatically rerouted along available backup paths in the service provider network 105 in the event of a failure. As such, VPLS provides a more reliable network solution compared to other network solutions for connecting distant LAN sites (e.g., WAN link to Ethernet switches, and the like), as failover—i.e., switching to a backup route in response to a failure in a primary link, in a primary route, or both—may be achieved faster than with the use of typical protocols (including, without limitation, spanning tree protocol and the like).

In a VPLS MPLS network, such as network 105, a two-label stack is typically created for each data packet, the outer label being used for normal MPLS packet switching as discussed above, while the inner label might be used to allow each PE router 110 to keep track of and associate the inner label with each VPLS instance.

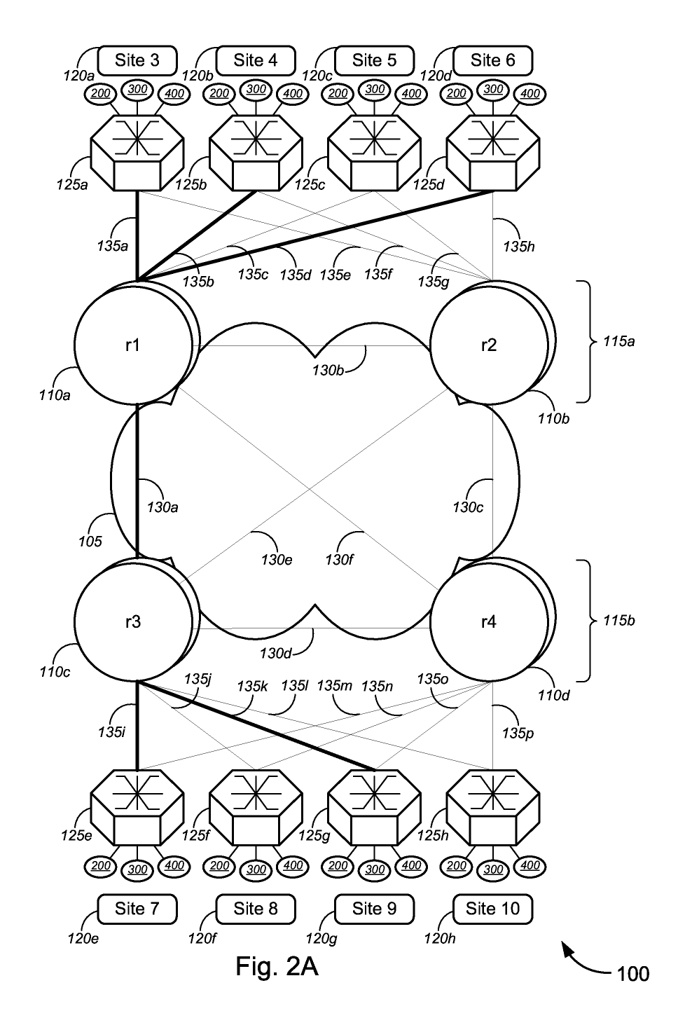

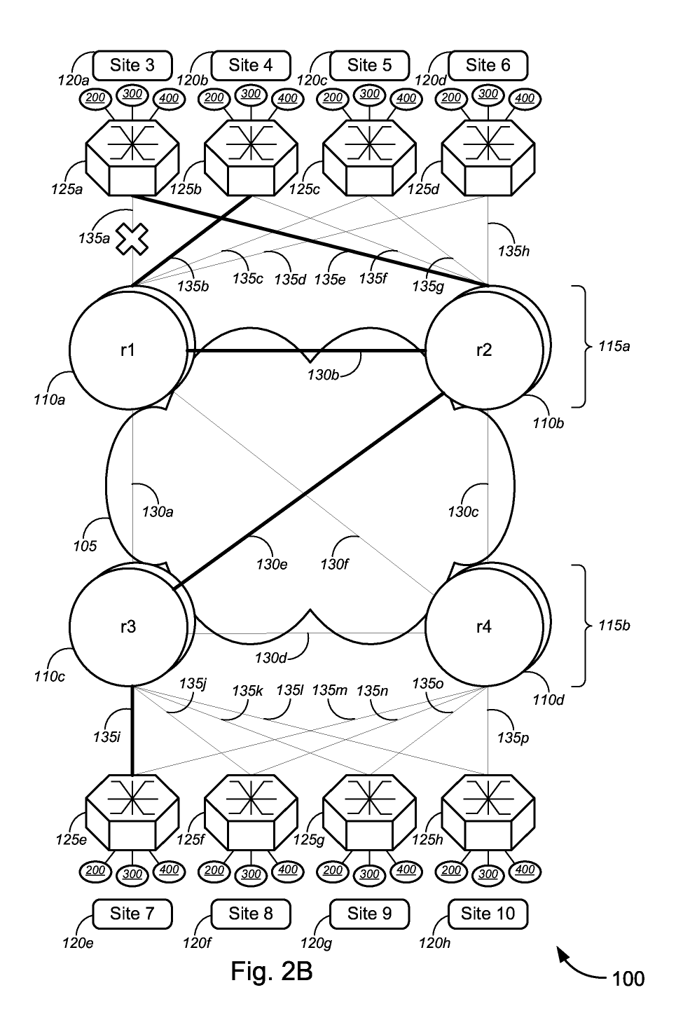

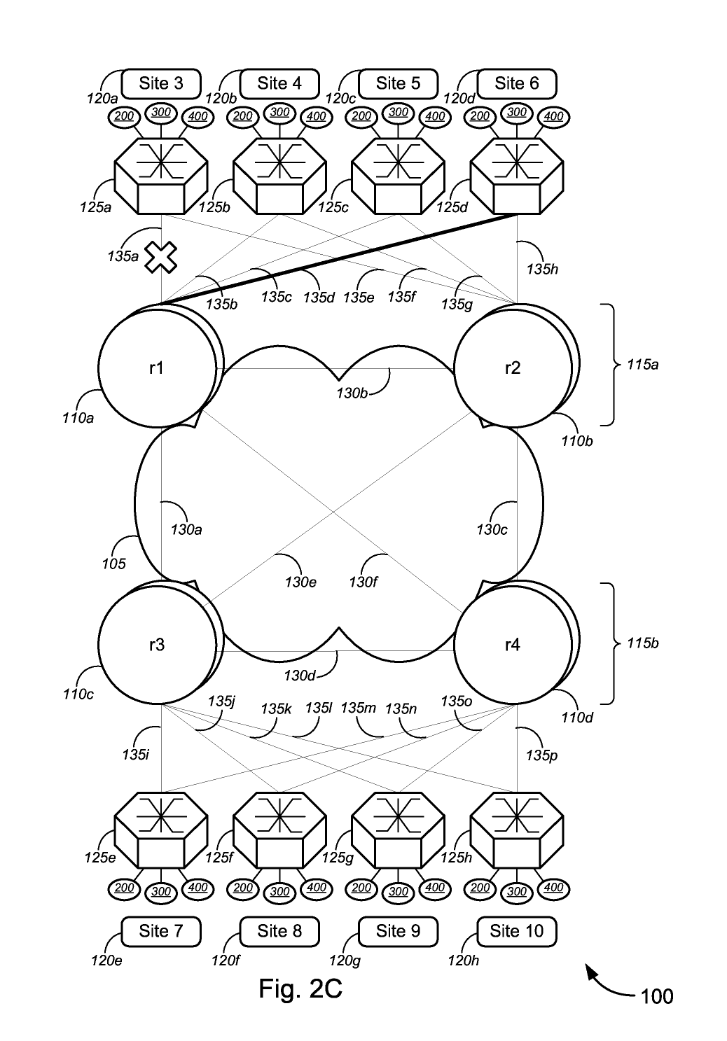

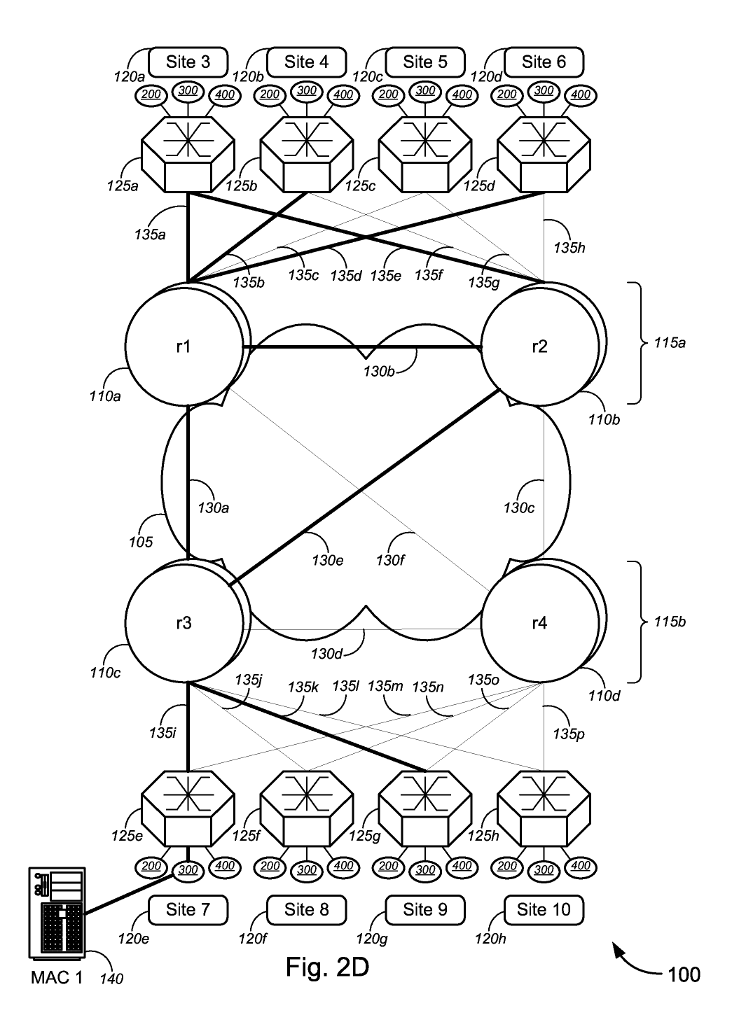

In operation, when a CE device 125 is connected with a PE router 110, the CE device 125 might send an Ethernet frame to the PE router 110. The PE router 110 might inspect the Ethernet frames and might learn the CE device's 125 MAC address. The PE router 110 might then locally store the MAC address of the CE device 125, along with the label switched path (“LSP”) routing information. The PE router 110 might subsequently analyze the Ethernet frame's destination MAC address, and might send the frame to all PE routers 110 in the mesh in the event that the MAC address is not already known to the PE router 110. A detailed description of the switching and routing of data packets within the VPLS Multi-homing Network is provided below with respect to FIGS. 2A-4B.

We now turn to FIGS. 2A-2D (collectively, “FIG. 2”), which show the VPLS Multi-homing Network 100 of FIG. 1 in normal operation and in operation with a failure.

FIG. 2A is a general schematic diagram of a VPLS Multi-homing Network 100 in operation, in accordance with various embodiments. Within an MPLS framework, such as within Juniper Network's VPLS Multi-homing architecture, the lowest numbered site pair within the sending POP (in the case of FIG. 1, the North POP) and the receiving POP (in this case, the South POP)—in this case, Site 3 and Site 7—might be used to establish label mapping for routing purposes within the VPLS context. For each VPLS instance (which corresponds to a certain VLAN), a table—such as a MAC table—might be populated with information learned remotely from either PE routers 110 in the network or the CE devices 125 in the network 100. Such information regarding either the PE routers 110 or the CE devices 125 might include, without limitation, MAC addresses of the respective components, the interface from which the MAC was learned (either link 135 or 130), and the like. Data packets in the MPLS framework will be sent from a sending device to a receiving device via the lowest numbered sets of PE devices as labeled according to the lowest numbered site pair.

For example, as shown in FIG. 2A, a first data packet might be sent from Site 3 (i.e., physical site 120a) to Site 7 (i.e., physical site 120e) within one of VLANs 200, 300, and 400. Within the MPLS network of the VPLS Multi-homing Network 100, the first data packet might be assigned labels to transfer the data packet from Site 3 to Site 7. As mentioned above, the MPLS and VPLS architecture might establish a route that connects the lowest numbered site-ids (120) associated to the CE devices 125 by analyzing the signaling information that MB-BGP provides. In this example, switch SW1 125a on the North POP is associated with the lowest numbered site ID 120a for the sending POP, while switch SW5 125e is associated with the lowest numbered site-id 120e for the receiving POP. Thus, PE routers r1 and r3, being the primary for Sites 3 and 7 (i.e., PE routers 110a and 110c) might constitute components within the path between those sites.

In operation, an attachment circuit (“AC”) link may be established along link 135a between CE switch 125a and PE router 110a (i.e., PE router r1), and data packets, which can be either IEEE 802.1q (VLAN) tagged or raw Ethernet packets might be sent along the link 135a to PE router r1, which might be an ingress LER for network 105. As discussed above, the ingress LER (e.g., router r1) might “push” the label onto the top of the label stack in the MPLS header of data packets. Another label at the bottom of the stack of the MPLS header that is associated the VC link established along link 130a between PE routers 110a and 110c (i.e., PE routers r1 and r3), and another attachment circuit or AC link may be established along link 135i between PE router 110c (i.e., PE router r3) and CE switch 125e. As each AC link or VC link is established, the first data packet may be routed along the established AC/VC links. Here, establishment of the VC link along link 130a and the AC link along link 135i might be a result of the routers r1 and r3 respectively routing the first data packet along links 130a and 135i, respectively, to Site 7. In FIG. 2A, links 135a, 130a, and 135i are shown highlighted to represent the route between Site 3 and Site 7 along which the first data packet might be sent.

In another example, data packets may be sent from one site within one POP to another site within the same POP. In particular, a second data packet might be sent from Site 3 (i.e., physical site 120a) to Site 4 (i.e., physical site 120b), both of which might be within the same POP (in this case, the North POP). In this case, PE router r1 (i.e., router 110a), which is the lowest numbered PE device on the North POP, might constitute a component within the path between Sites 3 and 4. In operation, an attachment circuit or AC link may be established along link 135a between CE switch 125a and PE router 110a (i.e., PE router r1), and the first data packet might be sent along the link 135a to PE router r1, which might be an ingress LER for network 105. As discussed above, the ingress LER (e.g., router r1) might “push” the label onto the top of the label stack in the MPLS header of the second data packet. Based on this label, an attachment circuit or AC link may be established along link 135b between PE router 110a (i.e., PE router r1) and CE switch 125b. The second data packet may then be sent along link 135b to Site 4. In FIG. 2A, links 135a and 135b are shown highlighted to represent the route between Site 3 and Site 4 along which the second data packet might be sent.

In yet another example, a third data packet might be sent from Site 6 (i.e., physical site 120d) to Site 9 (i.e., physical site 120g), within one of VLANs 200, 300, 400. As in the first example, PE routers r1 and r3 are the lowest numbered PE devices in the sending POP (i.e., North POP in this example) and in the receiving POP (i.e., South POP here), respectively. Accordingly, PE routers r1 and r3 (i.e., routers 110a and 110c, respectively) might constitute components within the path between Sites 6 and 9. As discussed above, the label might be “pushed” onto the top of the label stack in the MPLS header of the third data packet.

In operation, an attachment circuit or AC link may be established along link 135a between CE switch 125a and PE router 110a (i.e., PE router r1), and the third data packet might be sent along the link 135a to PE router r1, which might be an ingress LER for network 105. As discussed above, the ingress LER (e.g., router r1) might “push” the label onto the top of the label stack in the MPLS header of the third data packet. Based on this label, a virtual circuit or VC link may be established along link 130a between PE routers 110a and 110c (i.e., PE routers r1 and r3), and an attachment circuit or AC link may be established along link 135k between PE router 110c (i.e., PE router r3) and CE switch 125g. As each AC link or VC link is established, the third data packet may be routed along the established AC/VC links. Here, establishment of the VC link along link 130a and the AC link along link 135k might be a result of the routers r1 and r3 respectively routing the third data packet along links 130a and 135k, respectively, to Site 9. In FIG. 2A, links 135d, 130a, and 135k are shown highlighted to represent the route between Site 6 and Site 9 along which the third data packet might be sent.

FIG. 2B is a general schematic diagram of a VPLS Multi-homing Network in operation with a broken primary link, in accordance with various embodiments. In FIG. 2B, an outage or failure is shown occurring in the primary link (in this case, at link 135a between CE device 125a and PE router 110a). In other words, link 135a becomes broken, which might be due to one or a number of reasons known to those skilled in the art. Because the link 135a is broken, a new large scale integration (“LSI”) interface must be established to connect PE routers r1 and r2, and vice versa, and in some cases to connect all the PE routers in the network. In this example, Site 3 is no longer connected directly to PE router r1, and must reroute to PE router r2 in order to transfer data packets. In other words, the lowest numbered site pair is no longer Site 3 and Site 7; rather, the lowest numbered site pair is now Site 4 and Site 7. Accordingly, a new VPLS instance is established, in which case, a new table (such as a MAC table) might be populated with information regarding the PE routers 110 in the network, information regarding the CE devices 125 in the network 100, or both. In some cases, the information regarding the PE routers 110 might be received from other PE routers 110 in the MP-BGP mesh, and might include information regarding the broken link 135a.

Referring to the examples of the first through third data packets as discussed with respect to FIG. 2A, the outage or failure in the primary link (i.e., link 135a) might result in the following occurrences, especially if Junos code RFC 4761 is being implemented for the VPLS network 105.

The forwarding or packet switching performed by a PE router 110 (i.e., an LSR) might generally be based on the interface on which a data packet might be received (including, without limitation, an LSI interface and the like) and the destination MAC address of the data packet. A MAC table or the like may be used to store the interface, the destination MAC address, and the association between the interface and the destination MAC address for each data packet, each VPLS instance, or both. Updating of the MAC table might be performed by a MAC learning or MAC address learning process. In general, MAC learning or MAC address learning refers to a process in which source MAC addresses are associated with a receiving port of, or an LSI interface to, a remote PE router (such as one of PE routers 110 distant from a sending CE device). Thus, if the LSI interface changes due to a change in the status of the lowest numbered site pair in the network, the MAC table requires updating by MAC address learning. In other words, when the primary link associated with one of the lowest numbered site pair (i.e., link 135a) becomes broken or otherwise fails, MAC learning may be triggered. As a result, the MAC table may be updated with the new interfaces (e.g., new LSI interfaces), the new destination MAC addresses, and/or the new associations between interfaces and destination MAC addresses, or the like.

Any unknown destination MAC addresses, as well as any broadcast or multicast destination MAC addresses, might be forwarded or “flooded” to all ports and LSI interfaces (including those of remote PE routers 110) associated with the VPLS instance of the receiving interface, except for the interface on which the unknown/broadcast/multicast destination MAC addresses were received. On the other hand, known destination MAC addresses might be learned in the VPLS's forwarding information base (“FIB”), which might be a forwarding table used at each VPLS or MPLS hop for allowing a PE router (such as an LSR) to determine which outgoing interface is to receive the MPLS packet, and to determine what label to use when sending the packet out that interface. As such, the known destination MAC addresses might therefore be sent as unicast to associated interfaces or LSI interfaces (including those of remote PE routers 110).

For the first data packet, because CE switch 125a is unable to connect to PE router 110a (i.e., router r1) via broken link 135a, CE switch 125a necessarily must route to a different PE router 110. In this case, because the only other PE router to which CE switch 125a is connected is PE router 110b (i.e., router r2), CE switch 125a might send the first data packet to router r2 via link 135e.

Upon receiving the first data packet, router r2, which may serve as a LER, might create an MPLS header (if not already present in the data packet), might “push” a first label indicating the VPLS instance onto the label stack of the MPLS header, and might “push” a second label indicating the path on which to route the first data packet to Site 7 on top of the label stack. Because router r3 (i.e., PE router 110c) remains the lowest numbered PE device for the receiving POP (although Site 3 and Site 7 are no longer the lowest numbered site pairs), the second label might indicate that the path might include router r3, as well as any P router or PE router between router r2 and router r3; in the example as shown in FIG. 2B, however, there are no routers between routers r2 and r3, so the path would link router r2 directly with router r3. Serving as an LSR, router r2 (i.e., PE device 110b) might route the first data packet to router r3 (i.e. PE device 110c) via VC link or PW 130e.

When router r3 receives the first data packet, it might, while serving as an LSR, route the first data packet to CE device 125e based only on the top-most label in the label stack of the first data packet (i.e., the second label or MPLS routing label). Serving as an LER, router r3 might “pop” the second label off the label stack (in some embodiments, router r3 might also “pop” the first label or VPLS instance identification label off the label stack), prior to the first data packet being routed to CE switch 125e via link 135i. In other words, a first attachment circuit or AC link may be established along link 135e between CE switch 125a and PE router 110b (i.e., router r2), a virtual circuit or VC link may be established along link 130e between PE routers 110b and 110c (i.e., routers r2 and r3, respectively), and a second attachment circuit or AC link may be established along link 135i between PE router 110c (i.e., router r3) and CE switch 125e. In FIG. 2B, links 135e, 130e, and 135i are shown highlighted to represent the backup route between Site 3 and Site 7 along which the first data packet might be sent.

For the second data packet, CE switch 125a must reroute to PE router 110b (i.e., router r2) for the same reasons as for the first data packet. As discussed above, Sites 4 and 7 are now the lowest numbered site pairs, at least for the purposes of establishing the MAC table for routing within the VPLS network 105. Upon receiving the second data packet, router r2, which may serve as a LER, might create an MPLS header (if not already present in the data packet), might “push” a third label indicating the VPLS instance onto the label stack of the MPLS header of the second data packet, and might “push” a fourth label indicating the path on which to route the first data packet to Site 7 on top of the label stack of the second data packet. Because router r1 (i.e., PE router 110a) remains operational, despite the broken link 135a, router r1 may still be determined to be the lowest numbered PE device for the same POP, i.e., the North POP or POP 115a. Accordingly, the fourth label might indicate that the path might include router r1, as well as any P router or PE router between routers r2 and r1; in the example of FIG. 2B, however, there are no routers between routers r2 and r1, so the path would link router r2 directly with router r1. Serving as an LSR, router r2 (i.e., PE router 110b) might route the second data packet to router r1 (i.e., PE device 110a) via VC link or PW 130b.

Upon receiving the second data packet, the router r1 might, while serving as an LSR, route the second data packet to CE device 125b based solely on the top-most label in the label stack of the second data packet (i.e., the fourth label or MPLS routing label). As an LER, router r1 might “pop” the fourth label off the label stack (in some embodiments, router r1 might also “pop” the third label or VPLS instance identification label off the label stack), prior to routing the second data packet to CE switch 125b via link 135b. In other words, a third attachment circuit or AC link may be established along link 135e between CE switch 125a and PE router 110b (i.e., router r2), a virtual circuit or VC link may be established along link 130b between PE routers 110b and 110a (i.e., routers r2 and r1, respectively), and a fourth attachment circuit or AC link may be established along link 135b between PE router 110a (i.e., router r1) and CE switch 125b. In FIG. 2B, links 135e, 130b, and 135b are shown highlighted to represent the backup route between Site 3 and Site 4 along which the second data packet might be sent.

With reference to FIG. 2C, which is a general schematic diagram of a VPLS Multi-homing Network in operation in response to a broken primary link, a first limitation is illustrated with respect to a VPLS Multi-homing network based on Junos codes, particularly RFC 4761. The first limitation might arise between a first period when the primary link (i.e., link 135a in FIG. 2C becomes broken) and a second period when a new table (such as a MAC table) is established to take into account the broken primary link. In particular, prior to the first period (i.e., when the link 135a is still operational), the PE routers 110 might be utilizing a first LSI interface, which might be based on the lowest numbered site pair, Sites 3 and 7. As soon as the primary link (i.e., link 135a is broken), the first LSI interface is no longer a sufficient or appropriate interface to link the PE routers because Sites 3 and 7 are no longer the lowest numbered site pair (Sites 4 and 7 are now the lowest numbered site pair). A new LSI interface must be established to allow new PWs to be established amongst PE routers 110 in the VPLS network 105, which might occur at the second period. The establishment of the new PWs and the new LSI interface might, in some embodiments, be a result of affected Sites (i.e., site 3) attempting, and failing, to send data packets to router r1, such as discussed above with respect to the first and second data packets in FIG. 2B. Thus, in the time (which might be referred to as a “convergence time”) between the first and second periods, the PE router r1 does not know where to send any data packets from unaffected sites (i.e., sites not directly affected by the broken primary link). As a result, the convergence time might last a few seconds to multiple seconds (perhaps on the order of minutes), during which data packets sent to router r1 from unaffected sites (e.g., any of Sites 4-6) might be lost. The convergence time may be proportional to the number of VPLS instances, proportional to the number of VLANs, or both. For example, in a test with 500 VLANs, a convergence time of up to 28 seconds was recorded.

Referring to the example of the third data packet as discussed above with respect to FIG. 2A, prior to the first period, the third data packet might be sent from Site 6 to Site 9 via routers r1 and r3, using the first LSI interface. The first LSI interface might be based on a first table (e.g., a first MAC table), which might be established based on the lowest numbered site pair, Sites 3 and 7. As shown in FIG. 2C, Site 6 might otherwise be unaffected by the broken link 135a because link 135a is not in the path between Site 6 and Site 9. However, as soon as the primary link (i.e., link 135a) becomes broken—i.e., at the first period—Sites 3 and 7 cease to be the lowest numbered site pair. Accordingly, the first LSI interface, as well as the first table (e.g., first MAC table) upon which the first LSI interface might be based, might no longer be applicable for routing the third data packet. A new LSI interface must be established in order for routing to be performed among PE routers 110 in network 105. The new LSI interface might be established based on a second table (e.g., a second MAC table), which might be compiled in accordance to the new lowest numbered site pair, Sites 4 and 7. Until the new LSI interface is established, which might occur at the second period, PE router 110a (i.e., router r1) might be incapable of routing any data packets between unaffected sites (including Sites 4-6) to any other PE router in the network 105. Accordingly, between the first and second periods, data contained in the data packets (including, for example, the third data packet) from unaffected sites (including, for example, Site 6) might be lost. In FIG. 2C, only link 135d is shown highlighted to illustrate that data packets from an unaffected site (such as Site 6) might be lost during the time between the first and second periods.

As soon as the new LSI interface is established, at the second period, normal operations (such as described above with respect to FIG. 2A) may resume. In operation, after the second period, the LER or router r1 might “push” or “swap” a fifth label indicating the VPLS instance onto the label stack of the third data packet, and might “push” or “swap” a sixth label indicating the new MPLS routing information, based on the new LSI interface, on top of the label stack. Router r1, serving as an LSR, might subsequently route the third data packet to router r3 (i.e., PE device 110c) via VC link or PW 130a. Upon receiving the third data packet, router r3, serving as an LSR, might route the third data packet to CE device 125g (Site 9) based solely on the top-most label (i.e., the sixth label) in the label stack of the third data packet. As an LER, router r3 might “pop” the sixth (and perhaps also the fifth) label off the label stack, prior to routing the third data packet to CE switch 125g via link 135k.

FIG. 2D illustrates a second limitation with respect to a VPLS Multi-homing network based on Junos codes, particularly RFC 4761. The second limitation might arise after the broken primary link has been reestablished or fixed, and relevant VCs or PWs have not been promptly torn. In particular, a broadcast, such as an address resolution protocol (“ARP”), may result in mistakenly learning a source MAC address through a “back door.” Because a “MAC Flush” operation is not yet implemented in current Junos codes (including, but not limited to, RFC 4761), the MAC table will retain a MAC address associated with a wrong (i.e., old) LSI interface, until the MAC table's maximum age is reached, which could last up to about 10 minutes. As a result, all traffic destined to that MAC address might be lost until the relevant entry is flushed through a “timeout” operation, and correct MAC learning is performed. In various tests, a recurrence rate of 1 in 10 times was recorded for “back door” learning of the MAC addresses.

With reference to FIG. 2D, when broken link 135a has been fixed or reestablished, the VCs or PWs that were established using the new LSI interface (such as described with respect to FIGS. 2B-2C) to reroute the first through third data packets might still remain. Prior to these VCs or PWs being torn, such as when the original LSI interface has been reestablished, due to Sites 3 and 7 once again becoming the lowest numbered site pair (i.e., instead of Sites 4 and 7), a broadcast such as an ARP might mistakenly learn one or more source MAC addresses through a back door, including, without limitation, through a server or database. In this example, the back door might lead to MAC 1 server 140, which might be located at Site 7. Via VLAN 300, the one or more source MAC addresses might be sent through the VCs or PWs—for example, through PW or VC link 130a and AC link 135a to CE device 125a, through PW or VC link 130e and AC link 135e to CE device 125a and across AC link 135a to PE router r1, or through both. The one or more source MAC addresses, however, might be associated with the new LSI interface, rather than the original LSI interface. The new LSI interface (which might be based on Sites 4 and 7 being the lowest numbered site pair) would no longer be applicable when primary link (i.e., link 135a) is fixed or reestablished, at which time the original LSI interface (which might be based on Sites 3 and 7 being the lowest numbered site pair) might be applicable. Accordingly, similar to the situation with respect to the first limitation (discussed above with respect to FIG. 2C), data packets relying on the one or more source MAC addresses from MAC 1 server 140 might be lost until the one or more MAC addresses are flushed through a “timeout” operation, and correct MAC learning is performed. However, the “timeout” operation might not occur for a relatively long interval. In some cases, the interval could be as long as about ten minutes, during which countless data packets could have been lost.

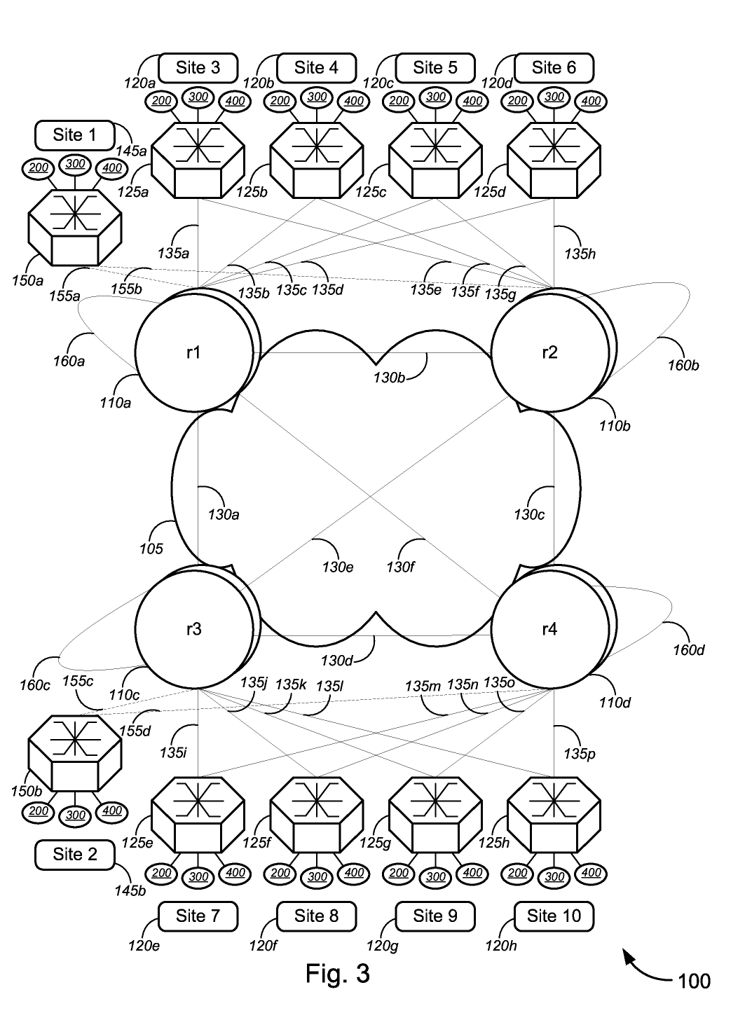

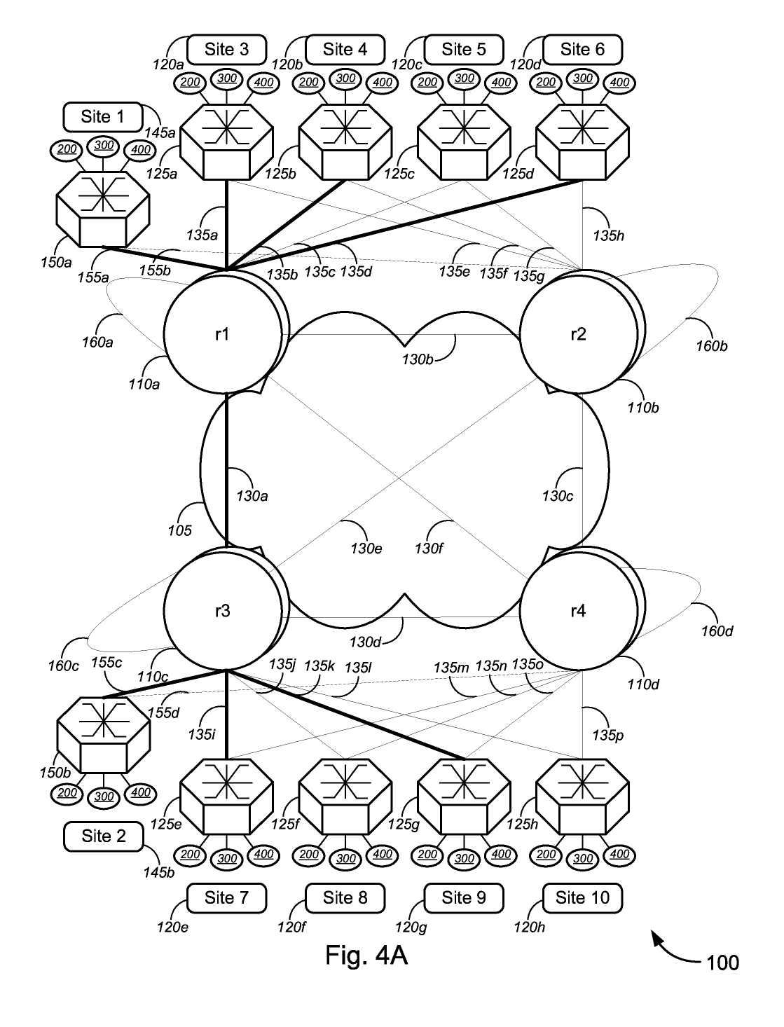

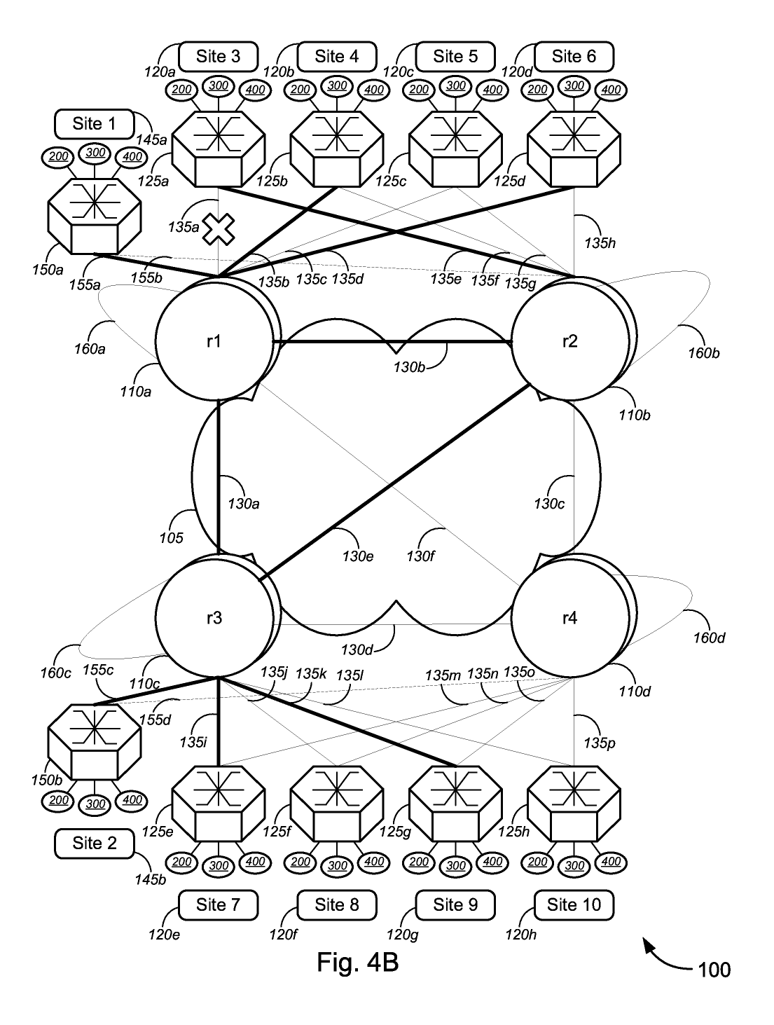

FIG. 3 and FIGS. 4A-4B illustrate various embodiments of a VPLS Multi-homing Network 100 that can address some of these issues. FIG. 3 is a general schematic diagram of a VPLS Multi-homing Network 100 with Stability Sites 145, in accordance with various embodiments. In FIG. 1, the VPLS Multi-homing Network 100 comprises network 105, a plurality of PE devices 110, one or more POPs 115, a plurality of physical sites 120, a plurality of CE devices 125, a plurality of virtual circuit (“VC”) links or pseudo-wires (“PWs”) 130, a plurality of attachment circuit (“AC”) links 135, two or more stability sites 145, a plurality of switches 150, a plurality of stability site links 155, a plurality of loopbacks 160, and one or more virtual local area networks (“VLANs”) 200, 300, and 400.

Network 105 is similar, if not identical, to network 105 as discussed above with respect to FIGS. 1-2. Likewise, the plurality of PE devices 110, the one or more POPs 115, the plurality of physical sites 120, the plurality of CE devices 125, the plurality of VC links or PWs 130, the plurality of AC links 135, and the one or more VLANs 200, 300, and 400 are similar, if not identical, to the corresponding components of the VPLS Multi-homing Network 100 as described above with respect to FIGS. 1-2.

In FIG. 3, the two or more stability sites 145 might comprise stability site 145a (otherwise referred to as “Site 1”) on the North POP or POP 115a and stability site 145b (otherwise referred to as “Site 2”) on the South POP or POP 115b. The plurality of switches 150 might comprise switches 150a and 150b, which might be located on the North POP and South POP, respectively. The plurality of stability site links 155 might comprise links 155a-155d. Links 155a and 155b might connect switch 150a to each of routers r1 and r2, respectively, while links 155c and 155d might connect switch 150b to each of routers r3 and r4, respectively. The plurality of loopbacks 160 might comprise loopbacks 160a-160d associated with each of routers r1-r4, respectively.

To address one or both of the first and second limitations (as described with respect to FIGS. 2C-2D), two or more stability sites 145 (which might comprise stability sites 145a and 145b) may be established in network 100. The two or more stability sites 145 might be reserved as the lowest numbered sites in network 100. In other words, the two or more stability sites 145 might be assigned site IDs that are the lowest numbered site IDs in the entirety of network 100. For example, stability site 145a might be designated as Site 1, while stability site 145b might be designated as Site 2, and the like.

Although FIG. 3 shows two stability sites—namely, stability site 145a on the North POP or POP 115a and stability site 145b on the South POP or POP 115b—the various embodiments are not so limited. For VPLS Multi-homing networks having hundreds or thousands of POPs, a stability site may be provided for each POP, with the lowest numbered Site IDs reserved for these stability sites.

According to some embodiments, two or more stability sites 145 might be implemented as virtual sites—rather than physical sites like Sites 3-10 discussed above. In particular, the two or more stability sites 145 might be implemented using physical loopbacks or virtual loopbacks. In some embodiments, a physical loopback might comprise physically looping a low speed port within the PE router to another low speed port using a network cable. The virtual loopback, according to some embodiments, might comprise establishing a logical loopback within the PE router. In some embodiments, a firewall filter may be applied to the looped interface. In other embodiments, the firewall filter may be omitted. In alternative embodiments, a physical site might be implemented in place of the virtual site. For example, the physical loopback might comprise connecting the low speed port of the PE router to a “low end” switch, which might be connected to each of the VLANs (including VLANs 200, 300, and 400), in a manner similar to Sites 3-10. In some cases, the “low end” switch might be physically located at one of the premises owned and/or operated by the service provider, and might be in close physically proximity to at least the lowest numbered PE router in each POP.

According to some embodiments, PE router 110a (i.e., router r1) or PE router 110c (i.e., router r3) might be the designated as the lowest numbered PE router amongst a plurality of PE routers 110 in network 105. PE router 110a or 110c might comprise at least a first port, a second port, and a third port.

The first port of PE router 110a might be communicatively coupled to a first lowest numbered CE device (e.g., CE switch 125a) located within a first customer site (e.g., Site 3) outside of the service provider network 105 via a first primary link (e.g., link 135a). The second port of PE router 110a might be communicatively coupled to a second PE router (i.e., one of routers r2-r4) within the service provider network 105 via a first primary virtual circuit (i.e., one of VC links or PWs 130a, 130b, and 130f). The first lowest numbered CE device (e.g., CE switch 125a) might be connected to a plurality of first VLANs 200, 300, and 400 at the first customer site (e.g., Site 3), the first customer site being a first lowest numbered physical site.

For the PE router 110c, on the other hand, the first port might be communicatively coupled to a third PE router (i.e., one of routers r1, r2, and r4) within the service provider network 105 via a second primary virtual circuit (i.e., one of VC links or PWs 130a, 130e, and 130d). The second port of PE router 110c might be communicatively coupled to a second lowest numbered CE device (e.g., CE switch 125e) located within a second customer site (e.g., Site 7) outside of the service provider network 105 via a second primary link (e.g., link 135i). The second customer site (e.g., Site 7) might be separate, or geographically distant, from the first customer site (e.g., Site 3). The second lowest numbered CE device (e.g., CE switch 125e) might be connected to a plurality of second VLANs 200, 300, and 400 at the second customer site (e.g., Site 7), the second customer site being the second lowest numbered physical site.

The third port of PE router 110a might be communicatively coupled to a stability site (e.g., stability site 145a or Site 1) via a first virtual circuit (e.g., link 155a), wherein the stability site (e.g., Site 1) might be located within the service provider network 105 and might be designated as a first lowest numbered virtual site. The first lowest numbered virtual site might have a site ID number (e.g., Site 1) lower than either the first lowest numbered physical site (e.g., Site 3) or the second lowest numbered physical site (e.g., Site 7).

The third port of PE router 110c might be communicatively coupled to a stability site (e.g., stability site 145b or Site 2) via a second virtual circuit (e.g., link 155c), wherein the stability site (e.g., Site 2) might be located within the service provider network 105 and might be designated as a second lowest numbered virtual site. The second lowest numbered virtual site might have a site ID number (e.g., Site 2) lower than either the first lowest numbered physical site (e.g., Site 3) or the second lowest numbered physical site (e.g., Site 7).

In response to at least one of the first primary link (e.g., link 135a) or the second primary link (e.g., link 135i) failing or becoming broken, one or more backup virtual circuits might be established between the second PE router (i.e., one of routers r2-r4) and the third PE router (i.e., one of routers r1, r2, and r4), without destroying the either the first or second virtual circuits (i.e., link 155a or link 155c).

In some embodiments, the third port of PE router r1 might be communicatively coupled to the stability site 145a via a first switch 150a, which might be located in the network 105 and might be in close physical proximity to at least PE router r1. Likewise, the third port of PE router r3 might be communicatively coupled to the stability site 145b via a first switch 150b, which might be located in the network 105 and might be in close physical proximity to at least PE router r3.

In other embodiments, the PE router r1 might comprise a fourth port, and the stability site 145a might comprise a physical loopback 160a communicatively coupled to the third port at one end and communicatively coupled to the fourth port at the other end. The third port, according to some embodiments, might include a logical port, and the stability site 145a might comprise a logical loopback 160a at the third port.

According to some embodiments, the PE router r3 might likewise comprise a fourth port, and the stability site 145b might comprise a physical loopback 160c communicatively coupled to the third port at one end and communicatively coupled to the fourth port at the other end. The third port, according to some embodiments, might include a logical port, and the stability site 145b might comprise a logical loopback 160c at the third port.

Referring back to FIG. 3, stability site 145a (i.e., Site 1) might be coupled via switch 150a to each of the PE routers on the North POP or POP 115a, namely to routers r1 and r2, via stability site links 155a and 155b, respectively. In some embodiments, stability site 145a might be connected to each of routers r1 and r2 via switch 150a, which might comprise a “low end” switch. Switch 150a, according to some embodiments, might be connected to each of VLANs 200, 300, and 400. In some cases, switch 150a might be in close physical proximity to at least router r1, which is the lowest numbered PE router on the North POP. According to some embodiments, rather than being connected via physical switch 150a, stability site 145a might be established as a virtual Site 1, by loopback 160a at router r1 and loopback 160b at router r2. Loopback 160a, according to some embodiments, might comprise physically connecting a first port (such as a low speed port) at router r1 (i.e., PE router 110a) with a second port (such as another low speed port) at router r1, by using a physical network cable. Likewise, loopback 160b might comprise physically connecting, via a physical network cable, a first port at router r2 (i.e., PE router 110b) with a second port at router r2; the first and second ports at router r2 might comprise low speed ports.

Similarly, stability site 145b (i.e., Site 2) might be coupled via switch 150b to each of the PE routers on the South POP or POP 115b, namely to routers r3 and r4, via stability site links 155c and 155d, respectively. In some embodiments, stability site 145b might be connected to each of routers r3 and r4 via switch 150b, which might comprise a “low end” switch. Switch 150b, according to some embodiments, might be connected to each of VLANs 200, 300, and 400. In some cases, switch 150b might be in close physical proximity to at least router r3, which is the lowest numbered PE router on the South POP. According to some embodiments, rather than being connected via physical switch 150b, stability site 145b might be established as a virtual Site 2, by loopback 160c at router r3 and loopback 160d at router r4. Loopback 160c might comprise physically connecting, via a physical network cable, a first port at router r3 (i.e., PE router 110c) with a second port at router r3; the first and second ports at router r3 might comprise low speed ports Likewise, loopback 160d, according to some embodiments, might comprise physically connecting a first port (such as a low speed port) at router r4 (i.e., PE router 110d) with a second port (such as another low speed port) at router r4, by using a physical network cable.

A principle of operation of the stability sites 145 is that because the stability sites 145 are either in physical proximity to each of the lowest numbered PE routers at each POP, or the stability sites 145 are implemented as virtual or logical loopbacks 160 within each of the lowest numbers PE routers at each POP, the AC links connecting the lowest numbered site pair to the lowest numbered PE routers on each POP and the VC link connecting the lowest numbered PE routers on each POP might never get torn down. As a result, regardless whether primary link 135a or 135i fails, the original LSI interface, which is based on Sites 1 and 2 as the lowest numbered site pair, might never need to be replaced with a new LSI interface. Accordingly, convergence time might be reduced to zero seconds because there is no changing of LSI interface soon after a primary link fails, thus addressing the first limitation Likewise, any “back door” lookup of source MAC addresses, soon after a broken primary link is reestablished, might have little to no effect in terms of data loss because the original LSI interface, which might be based on these same source MAC addresses, would remain applicable, thus addressing the second limitation. FIGS. 4A-4B illustrate the use of stability sites 145 in the context of the examples pertaining to the first through third data packets as discussed above with respect to FIGS. 2A-2D.

Although network 100 is shown in FIG. 3 establishing bridging Ethernet connections to each of only three VLANs, the various embodiments are not so limited. In particular, network 100, according to some embodiments, might establish bridging Ethernet connections to each of as many as 500 VLANs, and in other embodiments, 500 or more VLANs.

Turning to FIGS. 4A-4B (collectively, “FIG. 4”), a VPLS Multi-homing Network 100 comprising stability sites 145 is illustrated during normal operation (FIG. 4A) and with a broken primary link (FIG. 4B).

FIG. 4A is a general schematic diagram of a VPLS Multi-homing Network 100 with Stability Sites 145 in operation, in accordance with various embodiments. In FIG. 4A, network 100 is the same or similar to the network 100 in FIG. 2A, except that stability sites 145 are implemented in the manner as described with respect to FIG. 3.

For the first data packet, which is to be sent from Site 3 to Site 7, router r1 might “push” an MPLS label to the top of the label stack of the first data packet, and might route the first data packet to router r3 along VC link or PW 130a, based on an original LSI interface, which might be based on Site 1 and Site 2 being the lowest numbered site pair in network 100. In FIG. 4A, links 155a, 130a, and 155c are shown highlighted to represent the original LSI interface based on the lowest numbered site pair of Sites 1 and 2. Links 135a, 130a, and 135i are shown highlighted to represent the route between Site 3 and Site 7 along which the first data packet might be sent.

Likewise, router r1 might “push” an MPLS label to the top of the label stack of the second data packet, which is to be sent from Site 3 to Site 4. Router r1 might route the second data packet to CE 125b via link 135b, based on the original LSI interface, which might be based on Site 1 and Site 2 being the lowest numbered site pair in network 100. In FIG. 2A, links 135a and 135b are shown highlighted to represent the route between Site 3 and Site 4 along which the second data packet might be sent.

Similarly, for the third data packet, which is to be sent from Site 6 to Site 9, router r1 might “push” an MPLS label to the top of the label stack of the third data packet, and might route the third data packet to router r3 along VC link or PW 130a, based on the original LSI interface, which might be based on Site 1 and Site 2 being the lowest numbered site pair in network 100. In FIG. 4A, links 135d, 130a, and 135k are shown highlighted to represent the route between Site 6 and Site 9 along which the third data packet might be sent.

FIG. 4B is a general schematic diagram of a VPLS Multi-homing Network 100 with Stability Sites 145 in operation with a broken primary link 135a, in accordance with various embodiments. In FIG. 4B, although primary link 135a is broken or has otherwise failed, because the lowest numbered site pair (namely, Sites 1 and 2) remain connected and operational, the original LSI interface may continue to be used, without replacing it with a new LSI interface (as discussed with respect to FIGS. 2B-2D above). Accordingly, routing or rerouting of the first through third data packets might still be based on the original LSI interface.

For example, CE router 125a must send the first data packet to router r2 because primary link 135a between CE router 125a and router r1 is broken. Upon receiving the first data packet, r2 might establish VC link or PW 130e to router r3, which is the lowest numbered PE router in the South POP or POP 115b. Quite different from the example as described with respect to FIG. 2B, no MAC learning is necessary nor is a new LSI needed to be established. Rather establishing these backup routes along link 130e is based on the original LSI interface and based on the original MAC table because the lowest numbered site pair of Sites 1 and 2 remain operational. Router r3 might function in the same manner as described above with respect to FIG. 2B.

Similarly, for the second data packet, although a VC link or PW 130b is necessarily established between routers r2 and r1 (which remains the lowest numbered PE router in the North POP), such rerouting is based on the original LSI interface and based on the original MAC table. Routers r1 and r2 might otherwise function in the same manner as described above with respect to FIG. 2B.

For the third data packet, unlike in the example of FIG. 2C, no data is lost due to a long convergence time because there is no convergence time or because the convergence time has been reduced to zero seconds due to the PE routers relying on the original LSI interface and the original MAC table, without having to replace them with a new LSI interface or with a new or updated MAC table. Accordingly, data packets from unaffected sites may continue to be sent using the same labels. Thus, data may not be lost. The routing of the third data packet might otherwise function in the same manner as described above with respect to FIGS. 2A and 4A.

Regarding the limitation of “back door” MAC learning, even if source MAC addresses are being broadcast (such as using ARP), the source MAC addresses have not changed due to the original LSI interface and the original MAC table being utilized regardless of whether the primary link 135a becomes broken or whether the broken primary link 135a is reestablished. Accordingly, any such “back door” MAC learning might not affect routing or rerouting of data packets, unlike in the case as described above with respect to FIG. 2D.

To summarize, due to the use of stability sites 145, which might be designated as the lowest numbered sites in each POP with assigned site IDs reflecting this characteristic, the limitations of convergence time loss of data (first limitation) and of “back door” MAC learning loss of data (second limitation) might be, for all practical purposes, eliminated or at least diminished in effect.

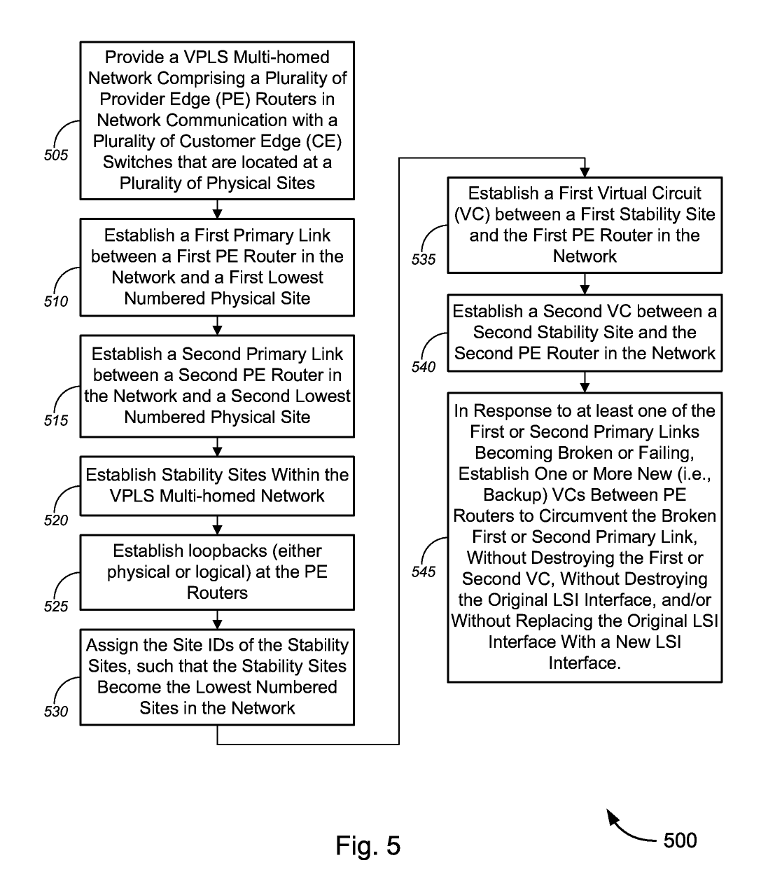

FIG. 5 is a flow chart of a method 500 of implementing Stability Sites 145 in a VPLS Multi-homing Network 100, in accordance with various embodiments. At block 505, method 500 might comprise providing a VPLS Multi-homed Network, which might comprise a plurality of PE routers in network communication with a plurality of CE switches that are located at a plurality of physical customer sites or customer premises. The plurality of physical customer sites or customer premises might be separate from the service provider's VPLS network or the service provider's facilities in which the VPLS network might be located. Exemplary VPLS Multi-home Networks are shown, for example, in the embodiments of FIGS. 1-4.

The method 500 might further comprise, at block 510, establishing a first primary link between a first PE router in the service provider network and a first lowest numbered physical site at one of the plurality of physical customer sites or customer premises. The first primary link might communicatively couple the first PE router with one of the plurality of CE switches at the first lowest numbered physical site.

The method 500 might further comprise establishing a second primary link between a second PE router in the service provider network and a second lowest numbered physical site at one of the plurality of physical customer sites or customer premises (block 515). The second lowest numbered physical site might be separate, and geographically distant, from the first lowest numbered physical site. The second primary link might communicatively couple the second PE router with one of the plurality of CE switches at the second lowest numbered physical site.

The method 500 might further comprise, at block 520, establishing a stability site for each POP within the VPLS Multi-homed Network. Establishing the stability site for each POP might comprise establishing loopbacks (either physical or logical) at the PE routers (block 525). As described above with respect to FIG. 3, each stability site might be established by one of the following three ways: (1) as a physical loopback; (2) as a virtual loopback; or (3) as a connection to a “low end” switch. In other words, in some embodiments, block 525 might be a sub-process of block 520. As described above, the physical loopback might comprise connecting, via a physical network cable, a first low speed port at each PE router in the VPLS network with a second low speed port at the same PE router. The virtual loopback might comprise establishing a logical loopback at each PE router in the VPLS network. The use of a “low end” switch might comprise connecting the first low speed port to a switch, which might be connected to each of the VLANs in the VPLS network. The switch, in some embodiments, might be located in the service provider VPLS network. In some cases, the switch might be in physical proximity to at least the lowest numbered PE router in each POP.

At block 530, method 500 might comprise assigning the site IDs of the stability sites, such that the stability sites become the lowest numbered sites in the VPLS network. The method 500 might further comprise, at block 535, establishing a first virtual circuit (“VC”) between a first stability site and the first PE router in the VPLS network, based on an original LSI interface and based on an original MAC table. At block 540, the method 500 might comprise establishing a second VC between a second stability site and the second PE router in the VPLS network, based on the original LSI interface and based on the original MAC table.

In response to at least one of the first primary link or second primary link becoming broken or failing, the method 500 might comprise establishing one or more new or backup VCs between PE routers in the network to circumvent or otherwise avoid the broken primary link, without destroying the first or second VC, without destroying the original LSI interface, and/or without replacing the original LSI interface with a new LSI interface (block 545). Because the original LSI interface is not destroyed or replaced with a new LSI interface, due to the lowest numbered sites never being torn down, loss of data due to convergence time loss of data and/or due to “back door” MAC learning may be avoided or otherwise mitigated.

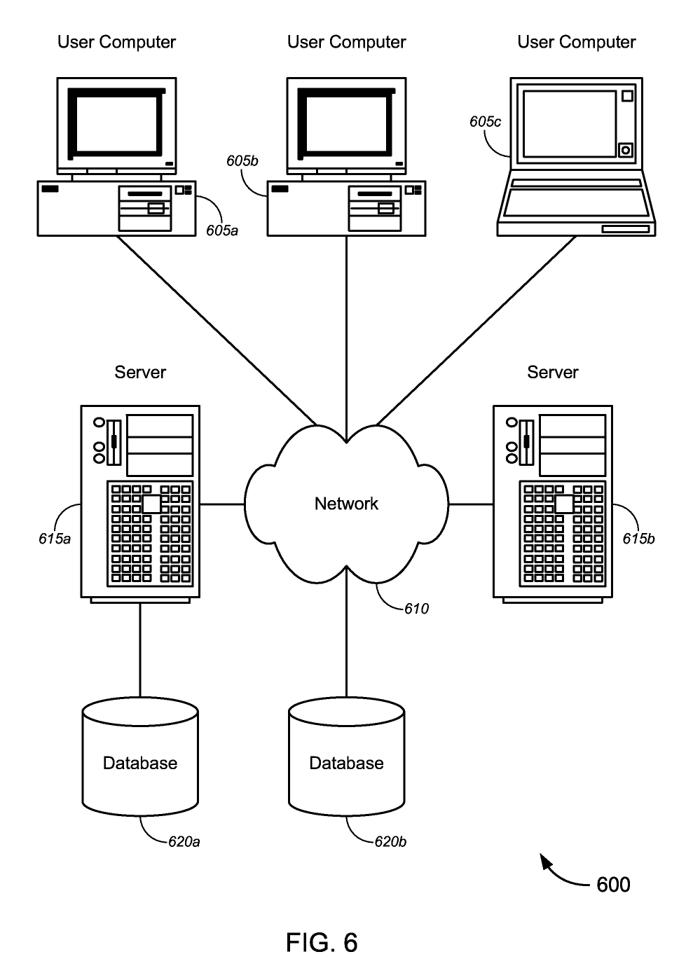

As noted above, a set of embodiments comprises systems for implementing a VPLS Multi-homing network. FIG. 6 illustrates a schematic diagram of a system 600 that can be used in accordance with one set of embodiments. The system 600 can include one or more user computers 605. A user computer 605 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer 605 can also have any of a variety of applications, including one or more applications configured to perform methods provided by various embodiments (as described above, for example), as well as one or more office applications, database client and/or server applications, and/or web browser applications. Alternatively, a user computer 605 can be any other electronic device, such as a thin-client computer, Internet-enabled mobile telephone, and/or personal digital assistant, capable of communicating via a network (e.g., the network 105 described above or the network 610 described below) and/or of displaying and navigating web pages or other types of electronic documents. Although the exemplary system 600 is shown with three user computers 605, any number of user computers can be supported.

Certain embodiments operate in a networked environment, which can include a network 105 or 610. The network 105 or 610 can be any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network 105 or 610 can include a local area network (“LAN”), including without limitation a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 may be a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™ IBM™ and the like, which can process requests from clients (including, depending on the configuration, dedicated database clients, API clients, web browsers, etc.) running on a user computer 605 and/or another server 615. In some embodiments, an application server can create web pages dynamically for displaying the information in accordance with various embodiments, such as displaying information contained in the data packets routed by the PE routers of the VPLS Multi-homing network. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 615a (and/or a user computer 605). Alternatively, a database 620b can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method for mitigating data loss during failover and recovery in a VPLS multi-homed network, the method comprising:
providing a VPLS multi-homed network comprising a first plurality of provider edge (“PE”) routers on a first point of presence (“POP”) within a service provider network and a second plurality of PE routers on a second POP within the service provider network, the first plurality of PE routers including a first primary PE router, the second plurality of PE routers including a second primary PE router, each of the first plurality of PE routers in network communication with a first set of customer edge (“CE”) devices located within one or more customer sites outside of the service provider network and served by the first POP, wherein the first set of CE devices provide access to a plurality of virtual local area networks (“VLANs”), wherein a first CE device in the first set of CE devices is assigned a lowest numbered site ID from among the first set of CE devices, each of the second plurality of PE routers in network communication with a second set of CE devices located within a plurality of customer sites outside of the service provider network and served by the second POP, wherein the second set of CE devices provide access to the plurality of VLANs, wherein a second CE device in the second set of CE devices is assigned a lowest numbered site ID from among the second set of CE devices;
establishing a first primary link between the first primary PE router and the first CE device;
establishing a second primary link between the second primary PE router and the second CE device;
establishing a first stability site within the service provider network;
associating the first stability site with a first interface that is configured to remain operational at all times;
communicatively coupling the first stability site to at least the first primary PE router via a first stable virtual circuit;
assigning the first stability site with a first virtual site ID, the first virtual site ID being lower than the site ID assigned to the first CE device;
establishing a second stability site within the service provider network;
associating the second stability site with a second interface that is configured to remain operational at all times;
communicatively coupling the second stability site to at least the second primary PE router via a second stable virtual circuit;
assigning the second stability site with a second virtual site ID, the second virtual site ID being lower than the site ID assigned to the second CE device; and
in response to at least one of the first primary link or the second primary link failing, establishing one or more backup virtual circuits between the first plurality of PE routers and the second plurality of PE routers, without destroying any of the first or second stable virtual circuits.

2. The method of claim 1, wherein establishing the first stability site comprises connecting a first switch to a port of at least the first primary PE router, and wherein establishing the second stability site comprises connecting a second switch to a port of at least the second primary PE router, the first and second switches being located at the service provider network.

3. The method of claim 1, wherein establishing the first stability site and establishing the second stability site comprises establishing a loopback of a plurality of loopbacks at each of the first and second plurality of PE routers, wherein the plurality of loopbacks includes at least one physical loopback, each physical loopback comprising a physical network connection between two ports of each of the first or second plurality of PE routers at which the physical loopback is established.

4. The method of claim 1, wherein establishing the first stability site and establishing the second stability site comprises establishing a loopback of a plurality of loopbacks at each of the first and second plurality of PE routers, wherein the plurality of loopbacks includes at least one virtual loopback, each virtual loopback comprising a logical loopback within each of the first or second plurality of PE routers at which the logical loopback is established.

5. The method of claim 1, wherein the first plurality of PE routers are configured to route data packets from the first set of CE devices using Junos code, based solely on labels in an MPLS header of the data packets, wherein the second plurality of PE routers are configured to route data packets from the second plurality of PE routers to the second set of CE devices using Junos code, based solely on labels in the MPLS header of the data packets.

6. The method of claim 5, wherein the Junos code comprises RFC 4761.

7. The method of claim 1, further comprising establishing one or more primary virtual circuits between the first plurality of PE routers and the second plurality of PE routers, wherein the first primary link, the second primary link, and one of the one or more primary virtual circuits or the one or more backup virtual circuits establishes a bridging connection linking the first set of CE devices with the second set of CE devices to provide access to the plurality of VLANs.

8. A VPLS multi-homed network system, comprising:
a first plurality of provider edge (“PE”) routers on a first point of presence (“POP”) within a service provider network, the first plurality of PE routers including a first primary PE router, each of the first plurality of PE routers in network communication with a first set of customer edge (“CE”) devices located within one or more customer sites outside of the service provider network and served by the first POP, wherein the first set of CE devices provide access to a plurality of virtual local area networks (“VLANs”), wherein a first CE device in the first set of CE devices is assigned a lowest numbered site ID from among the first set of CE devices;
a second plurality of PE routers on a second POP within the service provider network, the second plurality of PE routers including a second primary PE router, each of the second plurality of PE routers in network communication with a second set of CE devices located within a plurality of customer sites outside of the service provider network and served by the second POP, wherein the second set of CE devices provide access to the plurality of VLANs, wherein a second CE device in the second set of CE devices is assigned a lowest numbered site ID from among the second set of CE devices;
a first primary link established between the first primary PE router and the first CE device;
a second primary link established between the second primary PE router and the second CE device;
a first stability site communicatively coupled to at least the first primary PE router via a first stable virtual circuit, the first stability site located within the service provider network, the first stability site being associated with a first interface that is configured to remain operational at all times, wherein the first stability site is assigned with a first virtual site ID, the first virtual site ID being lower than the site ID assigned to the first CE device;
a second stability site communicatively coupled to at least the second primary PE router via a second stable virtual circuit, the second stability site located within the service provider network, the second stability site being associated with a second interface that is configured to remain operational at all times, wherein the second stability site is assigned with a second virtual site ID, the second virtual site ID being lower than the site ID assigned to the second CE device; and
one or more backup virtual circuits established between the first plurality of PE routers and the second plurality of PE routers, the one or more backup virtual circuits being established in response to at least one of the first primary link or the second primary link failing, wherein the one or more backup virtual circuits are established without destroying any of the first or second stable virtual circuits.

9. The system of claim 8, wherein the first stability site comprises a stability site established by connecting a first switch to a port of at least the first primary PE router, and wherein the second stability site comprises a stability site established by connecting a second switch to a port of at least the second primary PE router, the first and second switches being located at the service provider network.

10. The system of claim 8, wherein the first stability site comprises a stability site established by creating a first loopback of a plurality of loopbacks at each of the first plurality of PE routers, wherein the second stability site comprises a stability site established by creating a second loopback of the plurality of loopbacks at each of the second plurality of PE routers, wherein the plurality of loopbacks includes at least one physical loopback, each physical loopback comprising a physical network connection between two ports of each of the first or second plurality of PE routers at which the physical loopback is established.

11. The system of claim 8, wherein the first stability site comprises a stability site established by creating a first loopback of a plurality of loopbacks at each of the first plurality of PE routers, wherein the second stability site comprises a stability site established by creating a second loopback of the plurality of loopbacks at each of the second plurality of PE routers, wherein the plurality of loopbacks includes at least one virtual loopback, each virtual loopback comprising a logical loopback within each of the first or second plurality of PE routers at which the logical loopback is established.

12. The system of claim 8, wherein the first plurality of PE routers are configured to route data packets from the first set of CE devices using Junos code, based solely on labels in an MPLS header of the data packets, wherein the second plurality of PE routers are configured to route data packets from the second plurality of PE routers to the second set of CE devices using Junos code, based solely on labels in the MPLS header of the data packets.

13. The system of claim 12, wherein the Junos code comprises RFC 4761.

14. The system of claim 8, further comprising one or more primary virtual circuits established between the first plurality of PE routers and the second plurality of PE routers, wherein the first primary link, the second primary link, and one of the one or more primary virtual circuits or the one or more backup virtual circuits establishes a bridging connection linking the first set of CE devices with the second set of CE devices to provide access to the plurality of VLANs.

15. A provider edge (“PE”) router apparatus amongst a first plurality of PE routers in a VPLS multi-homed network, the PE router apparatus being a primary PE router on a first point of presence (“POP”) within a service provider network, the apparatus comprising:
a first port communicatively coupled, via a first primary virtual circuit, to a second PE router of a second plurality of PE routers on a second POP within the service provider network, or communicatively coupled, via a first primary link, to a first customer edge (“CE”) device in a first set of CE devices located within one or more customer sites outside of the service provider network and served by the first POP, wherein the first set of CE devices provide access to a plurality of virtual local area networks (“VLANs”), the first CE device being assigned a lowest numbered site ID from among the first set of CE devices;
a second port communicatively coupled, via a second primary virtual circuit, to a third PE router of the first plurality of PE routers on the first POP within the service provider network, or communicatively coupled, via a second primary link, to a second CE device in a second set of CE devices located within a plurality of customer sites outside of the service provider network and served by the second POP, wherein the second set of CE devices provide access to the plurality of VLANs, the second CE device being assigned a lowest numbered site ID from among the second set of CE devices; and
a third port communicatively coupled to a stability site via a first virtual circuit, wherein the stability site is located within the service provider network and is associated with an interface that is configured to remain operational at all times, wherein the stability site is assigned with a virtual site ID, the virtual site ID being lower than at least one of the site ID assigned to the first CE device or the site ID assigned to the second CE device,
wherein, in response to at least one of the first primary link or the second primary link failing, one or more backup virtual circuits is established between the second PE router and the third PE router, without destroying the first virtual circuit.

16. The apparatus of claim 15, wherein the third port is communicatively coupled to the stability site via a first switch.

17. The apparatus of claim 15, further comprising a fourth port, wherein the stability site comprises a physical loopback communicatively coupled to the third port at one end and communicatively coupled to the fourth port at the other end.

18. The apparatus of claim 15, wherein the third port includes a logical port, wherein the stability site comprises a logical loopback at the third port.

19. The apparatus of claim 15, further comprising a label switching module configured to read a label in an MPLS header of a data packet, and to route the data packet from the first CE device or to the second CE device, based solely on the label in the MPLS header of the data packet, wherein routing is performed using Junos code.

20. The apparatus of claim 19, wherein the Junos code comprises RFC 4761
